(19) United States
(12) Patent Application Publication
(10) Pub. No.: US 2015/0026407 A1
(43) Pub. Date: Jan. 22, 2015

(54) SIZE ADJUSTING CACHES BASED ON PROCESSOR POWER MODE

(71) Applicant: Advanced Micro Devices, Inc., Sunnyvale, CA (US)

(72) Inventors: Edward J. McLellan, Holliston, MA (US); Sudha Thiruvengadam, Austin, TX (US); Douglas R. Beard, Austin, TX (US); Carl D. Dietz, Columbia City, IN (US); Stephen V. Kosonocky, Fort Collins, CO (US)

(73) Assignee: Advanced Micro Devices, Inc., Sunnyvale, CA (US)

(21) Appl. No.: 13/946,125

(22) Filed: Jul. 19, 2013

(51) Int. Cl. G06F 12/08

(52) U.S. Cl. CPC G06F 12/0891; G06F 12/0864
USPC 711/128

(57) ABSTRACT

As a processor enters selected low-power modes, a cache is flushed of data by writing data stored at the cache to other levels of a memory hierarchy. The flushing of the cache allows the size of the cache to be reduced without suffering an additional performance penalty of writing the data at the reduced cache locations to the memory hierarchy. Accordingly, when the cache exits the selected low-power modes, it is sized to a minimum size by setting the number of ways of the cache to a minimum number. In response to defined events at the processing system, a cache controller changes the number of ways of each set of the cache.

### CROSS-REFERENCE TO RELATED APPLICATIONS

The present application is related to co-pending U.S. patent application Ser. No. ______ (Attorney Docket No. 1458-120229), entitled “SIZE ADJUSTING CACHES BY WAY” and filed on even date herewith, the entirety of which is incorporated by reference herein.

### FIELD OF THE DISCLOSURE

The present disclosure relates generally to processors and more particularly to processor caches.

### BACKGROUND

A multicore processor typically employs a memory hierarchy having multiple caches to store data for the processor cores. In some configurations, the memory hierarchy includes a dedicated cache for each processor core, one or more shared caches, and system memory. Each processor core stores data accessed recently or predicted to be accessed soon at its dedicated cache, stores data accessed less recently or predicted to be accessed somewhat later at the one or more shared caches, and stores data that is not predicted to be accessed (or predicted to be accessed much later) at the system memory. To enhance processor efficiency, the one or more shared caches are typically designed to have a relatively large capacity as compared to the dedicated caches. In addition, to reduce access latency to the memory hierarchy, the one or more shared caches are typically operated with a relatively high voltage as compared to the system memory. The one or more shared caches can therefore contribute significantly to the power consumption of the processor.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a processing system having a cache whose size can be adjusted by ways in accordance with some embodiments.

FIG. 2 is a diagram illustrating changing a size of the L2 cache of the processing system of FIG. 1 in accordance with some embodiments.

FIG. 3 is a timeline illustrating adjusting the size of the shared cache of FIG. 1 in accordance with some embodiments.

FIG. 4 is a flow diagram of a method of adjusting a size of a cache in accordance with some embodiments.

FIG. 5 is a flow diagram illustrating a method for designing and fabricating an integrated circuit device implementing at least a portion of a component of a processing system in accordance with some embodiments.

The use of the same reference symbols in different drawings indicates similar or identical items.

### DETAILED DESCRIPTION

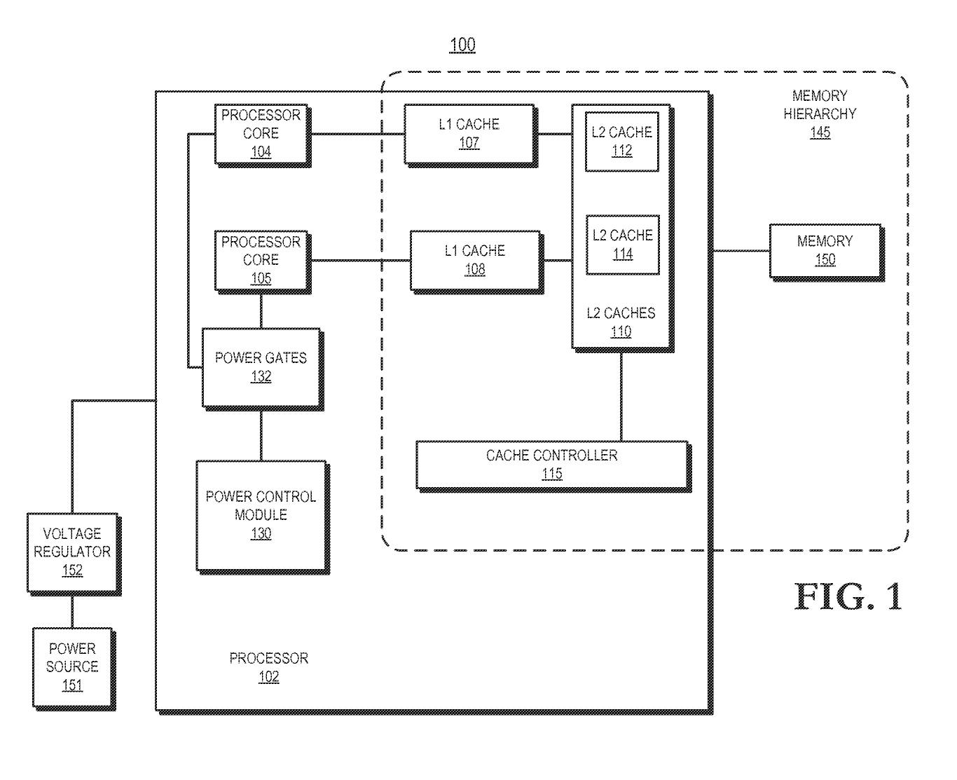

FIGS. 1-5 illustrate example techniques for reducing power consumption at a cache of a processor through reducing the size of the cache only when the processor exits one or more selected low-power modes. In some embodiments, as the processor enters the selected low-power modes, the cache is flushed of data by writing at least some data (e.g., modified data) stored at the cache to other levels of a memory hierarchy. The flushing of the cache allows the size of the cache to be reduced without suffering an additional performance penalty of writing the data at the reduced cache locations to the memory hierarchy. That is, because the data has already been flushed due to entering one of the selected low-power modes, an additional flush to preserve data at the reduced size cache is not necessary. Accordingly, when the cache exits the selected low-power modes, it is sized to a minimum size by setting the number of ways of the cache to a minimum number. In response to defined events at the processing system, a cache controller changes the number of ways of each set of the cache.

In some embodiments, the processor can also enter other low-power modes wherein data stored at the cache is retained (i.e. is not written to the memory hierarchy as part of the processor entering the low-power mode, but rather continues to be stored at the cache while the processor is in the low-power mode). For such low-power modes, reducing the size of the cache would require data at the reduced cache locations to be written to the memory hierarchy, imposing a performance penalty. Accordingly, the processor does not reduce the size of the cache when these low-power modes are entered. The processor thus balances performance of the processor with power consumption.

FIG. 1 illustrates a processing system 100 having a cache with an adjustable size in accordance with some embodiments. The processing system 100 can be used in any of a variety of electronic devices, such as a personal computer, server, portable electronic device such as a cellular phone or smartphone, a game system, set-top box, and the like. The processing system 100 generally stores and executes instructions organized as computer programs in order to carry out tasks defined by the computer programs, such as data processing, communication with other electronic devices via a network, multimedia playback and recording, execution of computer applications, and the like.

The processing system 100 includes a processor 102, a memory 150, a power source 151, and a voltage regulator 152. The power source 151 can be any source that can provide electrical power, such as a battery, fuel cell, alternating current source (e.g. an electrical outlet or electrical generator), and the like. In some embodiments the power source 151 also includes modules to regulate the form of the provided electrical power, such as modules to convert an alternating current to direct current. In either scenario, the power source 151 provides the electrical power via an output voltage. The voltage regulator 152 regulates the output voltage to provide a power supply voltage that it maintains within specified limits. The power supply voltage provides power to the processor 102, and can also provide power to other components of the processing system 100, such as the memory 150.

The memory 150 includes one or more storage devices that manipulate electrical energy in order to store and retrieve data. Accordingly, the memory 150 can include random access memories (RAM), hard disk drives, flash memories, and the like, or any combination thereof. The memory 150 is generally configured both to store the instructions to be executed by the processor 102 in the form of computer programs and to store the data that is manipulated by the executing instructions.

To facilitate the execution of instructions, the processor 102 includes multiple processor cores (e.g. processor cores 104 and 105). Each processor core includes one or more instruction pipelines to fetch, decode, dispatch, execute, and retire instructions. An operating system (OS) executing at the processor 102 assigns the particular instructions to be executed to each processor core. To illustrate, a particular sequence of instructions to be executed by a processor core is referred to as a program thread. A thread can represent either an entire a computer program or a portion thereof assigned to carry out a particular task. For a computer program to be executed, the OS identifies the program threads of the computer program and assigns (schedules) the threads for execution at the processor cores 104 and 105. To enhance processing efficiency, the processor cores 104 and 105 are configured to execute their assigned program threads (either from the same computer program or different computer programs) in parallel.

In some operating scenarios, there will be more threads to be executed than there are processor cores to execute them. In these scenarios, the OS selects and schedules the threads to be executed based on a defined prioritization scheme. The changing of the particular thread assigned to a given processor core is referred to as a context switch. The OS enhances processing efficiency by performing context switches in response to defined system conditions, such as a given executing thread awaiting data from the memory 150.

In some operating scenarios, there will be fewer program threads scheduled for execution at the processing system 100 than there are processor cores needed to execute the program threads. Accordingly, to conserve power, the processing system 100 includes a power control module 130 and power gates 132 that cooperate to control the power supplied individually to the processor cores 104 and 105. In some embodiments, the power gates 132 are implemented by a set of switches that are controlled by the power control module 130 to selectively couple and decouple, or reduce the level of, the voltage supplied by the voltage regulator 152 to the processor cores 104 and 105. The state of the switches, and the level of the voltage supplied by the voltage regulator 152 can be set by an operating system (OS) based on conditions, such as a level of processing activity (or expected level of processing activity) at the processor cores 104 and 105. Setting the amount of power (e.g. by setting a voltage level) provided to a processor core is referred to as setting a “power mode” (also referred to as a “power state”) for the processor core. Further, setting a power mode of a processor core so that the processor core does not carry out any processing activity, or carries out a substantially reduced amount of processing activity, is referred to as placing the processor core in a “low-power” mode or low-power state. Other mechanisms in addition or in alternative to power gates 132 to place a processor core in low power mode are known to those of ordinary skill.

In the course of executing instructions, each of the processor cores 104 and 105 stores and retrieves data from a memory hierarchy 145 that includes the memory 150 and a set of caches including level 1 (L1) caches 107 and 108 and level 2 (L2 caches) 110, including L2 cache 112 and L2 cache 114. The level of a cache indicates its position in the memory hierarchy 145, with the L1 caches 107 and 108 representing the highest level, the L2 caches 110 the next-lower level, and the memory 150 representing the lowest level. In the illustrated example, each of the L1 caches 107 and 108 is dedicated to a corresponding processor core (processor cores 104 and 105 respectively), such that each L1 cache only responds to load and store operations from the processor core to which it is dedicated. In contrast, the L2 caches 110 are shared between the processor cores 104 and 105, such that the L2 caches 110 can store and retrieve data on behalf of either processor core. In some embodiments, the L2 caches are assigned to particular executing threads, such that an L2 cache only stores data for the threads to which it is assigned.

The memory hierarchy 145 is configured to store data in a hierarchical fashion, such that the lowest level (the memory 150) stores all system data, and other levels store a subset of the system data. The processor cores 104 and 105 access (read or write) data in the memory hierarchy 145 via memory access operations, whereby each memory access operation indicates a memory address of the data to be accessed. In the event that a particular level of the memory hierarchy does not store data associated with the memory address of a received memory access, it requests the data from the next-lower level of the memory hierarchy. In this fashion, data traverses the memory hierarchy, such that the L1 caches 107 and 108 store the data most recently requested by the processor cores 104 and 105, respectively.

As used herein, the size of a cache refers to the number of entries of the cache that can be employed to respond to memory access operations. The L1 caches 107 and 108 and the L2 caches 110 are limited in size such that, in some scenarios, they cannot store all the data that is the subject of memory access operations from the processor cores 104 and 105. Accordingly, the memory hierarchy 145 includes a cache controller 115 to manage the data stored at each cache. To illustrate, in some embodiments the L1 caches 107 and 108 and the L2 caches 110 are configured as set-associative caches whereby each cache includes a defined number of sets with each set including a defined number of entries, referred to as ways. The cache controller 115 assigns each set of a cache to a particular range of memory addresses using a subset of the memory address, referred to as an index, such that each way of a set can only store data for memory addresses in its range. The number of sets in the cache is determined by the number of bits in the index. Within each set, the data for any memory address having a matching index may be stored in any of the ways. The memory locations stored in the ways are identified by a different subset of the memory address bits, referred to as the tag. Although the cache controller 115 is illustrated as being shared by the caches 107, 108, 110, it is contemplated that in some embodiments, its functionality may be distributed such that each cache 107, 108, 110 has its own control logic.

In response to receiving a memory access operation for a particular cache, the cache controller 115 determines which set includes the memory address of the memory access operation in its assigned range. The cache controller 115 then determines whether one of the ways of the set stores data associated with the memory address and, if so, satisfies the memory access operation. The cache controller 115 uses the index bits to identify the set, and then concurrently checks all of the ways of the set to determine if any of the ways include entries corresponding to the tag. If none of the ways of the set stores data associated with the memory address, the cache controller 115 determines whether there is an available and empty way to store the data associated with the memory address. A way is empty to store the data if it does not store valid data associated with another memory address in the set's memory address range. As used herein, a way is not available if the way is not represented by a tag array or other data structure that allows the way to be accessed. Similarly, as used herein, a way is available if it is represented by the tag array or other data structure without reconfiguration of the structure. A way that has been transitioned from being available to being unavailable is referred to as having been removed from the cache.

If there is an empty way, the cache controller 115 assigns the empty way to the memory address and satisfies the memory access operation, either (in the case of a store operation) by storing data associated with the memory access operation or (in the case of a load operation) by retrieving data associated with the memory address from lower levels in the memory hierarchy 145, storing it at the selected way, and providing the retrieved data to the requester.

If the cache controller 115 determines there is not an empty way for a given memory access operation, it selects one of the ways of the set for replacement based on a defined replacement algorithm, such as a least-recently-used (LRU) algorithm, most-recently used (MRU) algorithm, random replacement algorithm, and the like. The cache controller 115 evicts the selected way by transferring the data stored at the selected way to the next-lower level of the memory hierarchy 145, and then satisfies the memory access operation at the selected way.

For the L2 caches 110, the cache controller 115 can adjust the size of the caches based on defined conditions as described further herein. In particular, each of the L2 caches 110 is configured as a set-associative cache, with a given number of ways in each set. The cache controller 115 adjusts the size of a given L2 cache by changing the number of ways assigned to each set of the cache. To illustrate, L2 cache 112 can have a sufficient number of bit cells to implement an M-way set-associative cache. However, the cache controller 115 can limit the number of ways assigned to each set to N ways, where N is less than M, as described further below. Because the use of each way in a set consumes power, limiting the size of an L2 cache can reduce power consumption at the processor 102, at the cost of a potentially higher cache eviction rate and reduced processing efficiency. To ensure that the size limit placed on an L2 cache does not unduly impact processing efficiency, the cache controller 115 can adjust the sizes of the L2 caches 110 over time based on defined criteria, such as processing efficiency, the power state of one or more processor cores, switching of threads at a processor core, and the like.

To illustrate, in some embodiments the processor 102 can identify an amount of processing activity at one or more of the processor cores 104 and 105 using a hardware performance monitor, performance monitoring software, prediction and the like, or a combination thereof. For example, a hardware performance monitor could monitor the rate at which instructions are retired at the processor cores 104 and 105. Based on this performance measurement, the cache controller 115 can adjust the size of each of the L2 caches 110 accordingly. For example, if the processor core 104 is using the L2 cache 112, and the rate of instruction retirement indicates a high level of processing activity, the cache controller 115 can increase the number of ways in each set of the L2 cache 112 to increase the number of resources available to the processor core 104. If the rate of instruction retirement indicates a low level of processing activity, the cache controller 115 can reduce the number available ways in each set of the L2 cache 112, thereby conserving power while still providing enough ways for the processor core 104 to operate efficiently.

In some embodiments, each of the processor cores 104 and 105 can enter and exit different power modes, whereby a higher power mode indicates a higher level of processor activity and a lower power mode indicates a lower level of processor activity. Accordingly, the cache controller 115 can set the size of the L2 caches 110 based on the power states of each of the processor cores 104 and 105. For example, if the processor core 105 is using the L2 cache 112, and the processor core 105 enters a lower power mode, indicating a reduced amount of processing activity, the cache controller 115 can decrease the number of ways in each set of the L2 cache 112 to conserve power. If the processor core 105 later returns to a higher power mode, in response the cache controller 115 can increase the number of ways at each set of the L2 cache 112 to account for the increased processing activity. The cache controller 115 thereby maintains processing efficiency for the processor core 105 during periods of high activity while conserving power during periods of lower activity when all of the ways of the L2 cache 112 are less likely to be utilized.

When the number of ways at each set of the cache 112 is reduced, such that some ways are removed, the memory hierarchy 145 preserves the data from the removed ways. In some embodiments, the L2 caches 112 and 114 are write-through caches, whereby when data is stored at one these caches the data is, as a matter of course, copied to other levels of the memory hierarchy, such as the memory 150. In such embodiments, the number of ways of the L2 caches 112 and 114 can be decreased without transferring data from the removed ways to the memory 150, because the data has previously been transferred via the write-through process. In some embodiments, the L2 caches 112 and 114 are write-back caches, whereby data at a cache way is only transferred to another level of the memory hierarchy 145 in response to the data at the way being replaced.

In such embodiments, when the number of ways of a cache is reduced, the data at the reduced ways is flushed by copying the data to another level of the memory hierarchy 145, such as to the memory 150. After being flushed, the cache is in a “post-flush state”, whereby it no longer stores any unique or exclusive data. That is, it no longer stores any data that is not also stored at another level of the memory hierarchy 145. Prior to being flushed, the cache is in a “pre-flush” state, whereby it may store exclusive or unique data that is not stored at another level of the memory hierarchy 145 because, for example, the data at the cache has recently been modified and the modified data has not yet been copied to another level of the memory hierarchy 145.

The flush operation may impose a performance penalty at the L2 caches 112 and 114, and this performance penalty can be taken into account as the processor 102 determines whether the size of one of the L2 caches 112 and 114 can be reduced. Thus, in some embodiments, the L2 caches 112 and 114 may be flushed in response to one or more of the processor cores 104 and 105 entering a selected low-power mode, such as a sleep mode wherein the processor core will not carry out any processing activity. That is, one step in the sequence of the processor core entering the sleep mode includes the data at one or more of the L2 caches 112 and 114 being copied to another level of the memory hierarchy 145, such as the memory 150. Low-power modes that result in flushing of one of the L2 caches 112 and 114 are referred to for purposes of description as “post-flush” low-power modes. For the post-flush low-power modes, because the data at the cache has already been flushed, the cache controller 115 may reduce the size of the flushed cache without an additional performance penalty. Accordingly, in some embodiments the cache controller 115 reduces the size of the L2 caches 112 and 114 only when one or more of the processor cores 104 and 105 enters a post-flush low-power mode. In contrast, when the processor cores 104 and 105 enter power modes wherein the data stored at the L2 caches 112 and 114 are not copied to other levels of the memory hierarchy 145 in response to the power mode being entered (referred to as “pre-flush low power modes”), the cache controller 115 maintains the size of the L2 caches 112 and 114 at whatever size they were at when the pre-flush low-power mode was entered.

In some embodiments, the cache controller 115 adjusts the size of one or more of the L2 caches 110 in response to a context switch at one of the processor cores 104 and 105, wherein the context switch indicates the processor core has switched from executing one thread to executing another thread. For example, after a thread switch the executing thread may be likely to require a high degree of processing activity. Accordingly, the cache controller 115 can increase the size of one or more of the L2 caches 110 in order to account for the expected amount of processing activity.

In some embodiments, the cache controller 115 does not respond to all indications of processor activity changes, but instead periodically polls the processor cores 104 and 105 about their levels of processing activity and makes commensurate adjustments in the sizes of the L2 caches 110. Such periodic adjustment can reduce the likelihood of frequent adjustments in the sizes of the L2 caches 110, thereby improving processing efficiency.

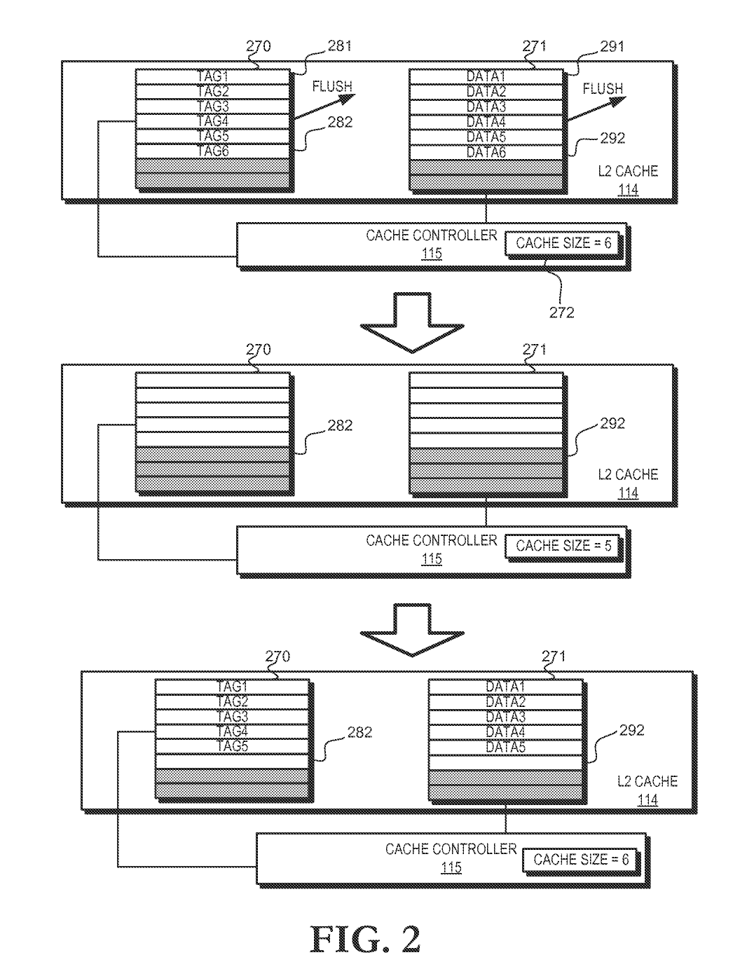

FIG. 2 illustrates an example of the changing of the cache size for the L2 cache 114 based on entering a flushed low power mode. In the illustrated example, the L2 cache 114 includes a tag array 270 and a set 271. For clarity of illustration, the other sets of the L2 cache 114 are not depicted, but when the L2 cache 114 is increased or reduced in size, each set is correspondingly increased or reduced as described below with respect to set 271.

In the illustrated example, the set 271 includes a number of ways, such as ways 291 and 292, whereby each way is a set of bit cells that can store data. The storage and retrieval of data from a way requires the switching and maintenance of the bit cells' transistors to defined states, thereby consuming power. Accordingly, the amount of power consumed by the L2 cache 114 depends in part upon the number of ways used to store data. Thus, by limiting the number of ways of the L2 cache 114 that store data, the cache controller 115 reduces the power consumption of the L2 cache 114 at the potential cost of an increased cache eviction rate and commensurate reduced processing efficiency.

The tag array 270 includes a number of entries, such as entries 281 and 282, with each entry able to store a tag indicating the memory address of the data stored at a corresponding way of the sets of the L2 cache 114. For a memory access operation, a processor core supplies to the cache controller 115 a tag indicating the memory address associated with the memory access operation. The cache controller 115 supplies the received tag to the tag array 270, which provides an indication as to whether it stores the supplied tag. If the tag array 270 does store the tag, it indicates a cache hit and in response the cache controller 115 uses the memory address of the memory access operation to access the way that stores the data associated with the memory address.

If the tag array 270 does not store the tag, it indicates a cache miss and the cache controller 115 retrieves the data associated with the memory address from the memory 150. In response to receiving the data, the cache controller 115 determines if there is an available way to store the data and, if so, stores the data at the available way. In addition, the cache controller 115 stores the tag for the memory address of the data at the tag array 270. If there is not an available way, the cache controller 115 selects a way for eviction based on an eviction policy (e.g. an LRU policy) and evicts the data from the selected way by storing the retrieved data at the selected way. In addition, the cache controller 115 replaces the tag for the evicted data with the tag for the retrieved data.

In some embodiments, the cache controller 115 sets the size of the L2 cache 114 by setting the number of entries of the tag array 270 that are used, and the number of ways of the set 271 (and for each other set of the L2 cache 114). To illustrate, in the depicted example the cache controller 115 includes a cache size register 272 that stores a size value indicating the size of the L2 cache 114. The size value governs the number of entries the cache controller 115 uses at the tag array 270 and the number of ways of each set of the L2 cache 114 that are used to store data. In FIG. 2, tag array entries and ways that are available for use are illustrated with a white background and tag array entries and ways that are not available for use are illustrated with a gray background. Accordingly, in the illustrated example the tag array entry 282 and the way 292 are initially unavailable for use.

In the example of FIG. 2, the cache controller 115 initially sets the size of the L2 cache 114 to six, such that there are six entries available at the tag array 270 for set 271, and sixth corresponding ways of set 271. In response to receiving an indication that the processor core 104 is going to enter a post-flush low-power mode, the cache controller 115 flushes the data from the ways of set 271 by copying the data to the memory 150. In addition, because the data has been flushed and there is therefore no performance penalty for reducing the size of the cache 114, the cache controller 115 reduces the number of ways at the cache size register to five. Accordingly, after the processor core 104 exits the post-flush low-power mode, the cache 114 has 5 available ways at the set 271 to store data.

In addition, in the example of FIG. 2, the cache controller 115 increases the value at the cache size register 272 to six in response to a defined event at the processing system 100, such as an increase in processing activity. This causes way 292, and the corresponding tag array entry 282, to become available to respectively store data and a corresponding tag. Accordingly, in response to receiving a sixth tag associated with a memory access the cache controller 115 supplies the sixth tag to the tag array 270, which indicates a cache miss. In response, the cache controller 115 retrieves the data associated with the memory address of the memory access. In addition, the cache controller 115 determines that the set 271 stores five valid data entries, which is less than the maximum number indicated by value stored at the cache size register 272. Accordingly, the cache controller 115 stores the retrieved data at the available way 292 and the corresponding tag at entry 282. Thus, way 292 is not used until, for example, processing activity exceeds a threshold, thereby conserving power until activity at the processing cores 104 and 105 is such that processing efficiency is likely to be unduly impacted.

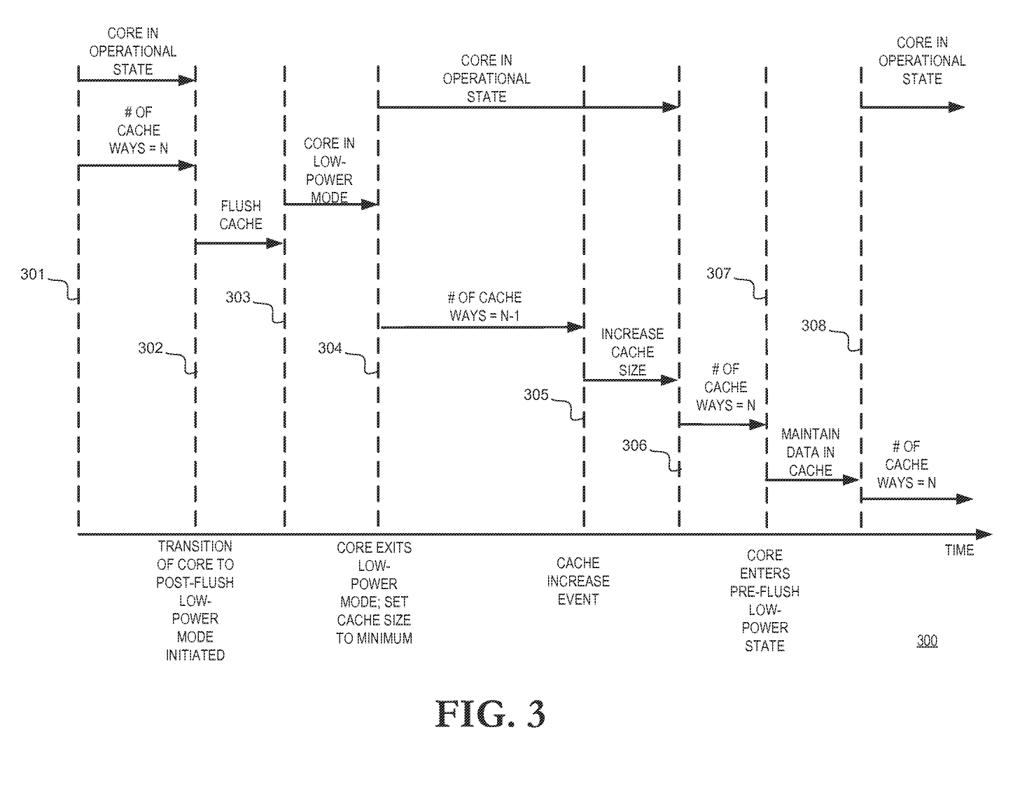

FIG. 3 illustrates a timeline 300 showing an example of the cache controller 115 adjusting the size of an L2 cache in accordance with some embodiments. For purposes of illustration, FIG. 3 is described with respect to adjustment of the size of L2 cache 114. At time 301 the processor core 105 is in a normal, operational power mode whereby it is executing instructions. Further, the size of the cache 114 has previously been set to a size N. At time 302, it is identified that the processor core 105 is expected to have a reduced amount of processing activity. This identification can be made by an operating system (OS) executing at the processor 102, by a hardware module of the processor 102, or a combination thereof. In response, the OS or the hardware module, or combination thereof identifies that the processor core can a post-flush low-power mode. Accordingly, between time 302 and 303 the cache controller 115 flushes the data stored at the ways of the cache 114 by copying that data to the memory 150. Between time 303 and 304 the processor core 105 is in the post-flush low-power mode (in the depicted example, a sleep state). At time 304, the OS causes the processor core 105 to exit the post-flush low-power mode in response to defined system conditions, such as an expected increase in processing activity at the processor core 105. In response to the processor core 105 having been in the post-flush low-power mode, the cache controller 115 sets the size of the cache 114 to a smaller size (N−1) than before the processor core 105 entered the low-power mode.

At time 305, the cache controller 115 determines that a cache increase event has occurred, such as a thread switch or processing activity at the processor core 105 has exceeded a programmable threshold. The cache increase event indicates that the program thread executing at the processor core 105 is experiencing a high level of memory access activity, such that a limited L2 cache size may adversely impact processing efficiency. Accordingly, at time 306 the cache controller 115 increases the size of the L2 cache 114 to from N−1 to N, such that each set of the cache includes N ways.

At time 307, the OS places the processor core 105 in a pre-flush low-power mode in response to defined system conditions, such as the processor core 105 awaiting a response from a system peripheral or other condition. Because the low-power mode is a non-flushed mode, the data stored at the cache 114 is not flushed, but instead is maintained at the cache 114. Accordingly, when the processor 105 exits the pre-flush low-power mode at time 308, the cache controller 115 does not reduce the size of the cache 114, but instead maintains the size at size N. Thus, the cache controller 115 reduces the size of the cache 114 only when the processor core 105 enters a post-flush low-power mode so that the processor 102 does not experience a performance penalty from reducing the cache size.

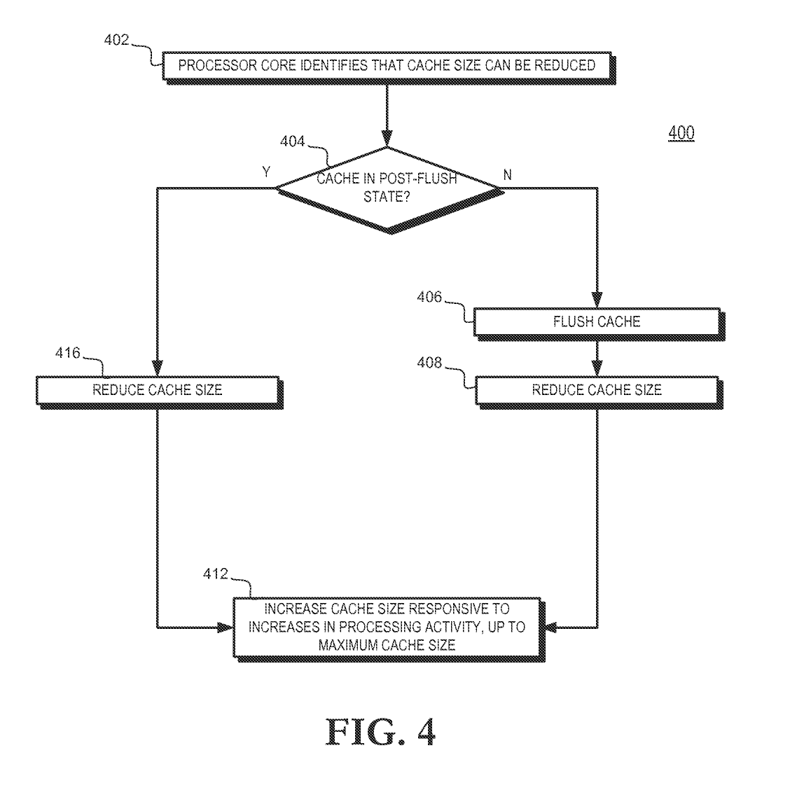

FIG. 4 illustrates a flow diagram of a method 400 of adjusting the size of a cache in accordance with some embodiments. The method 400 is described with respect to an example implementation at the processing system 100 of FIG. 1. At block 402 the processor core 104 identifies, based on defined system conditions (e.g. a reduced amount of processing activity) that the size of the L2 cache 112 can be reduced. At block 404 the processor core 104 identifies whether L2 cache 112 is in a post-flush state, wherein it does not store exclusive or unique data that is not stored at another level of the memory hierarchy 145. The L2 cache 112 may be in the post-flush state as a result of, for example, the processor core 104 having recently been in a post-flush low-power mode. If the low-power mode is a not in a post-flush state, the method flow moves to block 406 and the cache controller 115 flushes the data at the L2 cache 112 by copying the data store at the cache 112 to the memory 150. At block 408 the cache controller 115 reduces the size of the cache 112 to a defined minimum size by reducing the number of ways in each set of the cache 112 to the defined minimum. The method flow proceeds to block 412 and the cache controller 115 subsequently increases the size of the cache 112 in response to defined conditions, such as an increase in processing activity at the processor core 104, up to a defined maximum size.

Returning to block 404, if the L2 cache 112 is in a post-flush state, the method flow moves to block 416 and the cache controller 115 reduces the size of the L2 cache 112 without flushing it, as it is already in the post-flush state. The method flow proceeds to block 412 and the cache controller 115 subsequently increases the size of the cache 112 in response to defined conditions, such as an increase in processing activity at the processor core 104, up to a defined maximum size.

In some embodiments, the apparatus and techniques described above are implemented in a system comprising one or more integrated circuit (IC) devices (also referred to as integrated circuit packages or microchips), such as the processor described above with reference to FIGS. 1-4. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

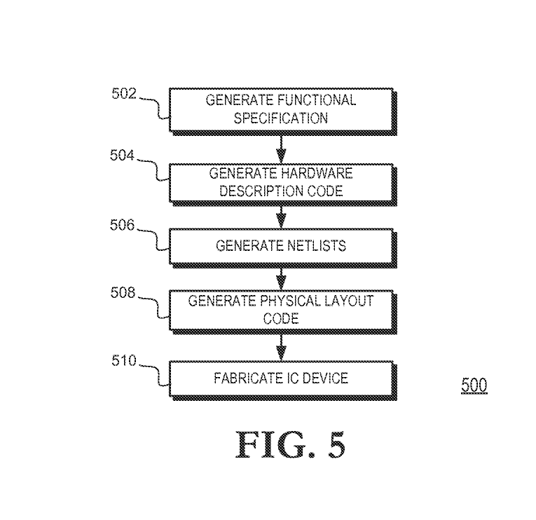

FIG. 5 is a flow diagram illustrating an example method 500 for the design and fabrication of an IC device implementing one or more aspects in accordance with some embodiments. As noted above, the code generated for each of the following processes is stored or otherwise embodied in computer readable storage media for access and use by the corresponding design tool or fabrication tool.

At block 502 a functional specification for the IC device is generated. The functional specification (often referred to as a micro architecture specification (MAS)) may be represented by any of a variety of programming languages or modeling languages, including C, C++, SystemC, Simulink, or MATLAB.

At block 504, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 506 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 508, one or more EDA tools use the netlists produced at block 506 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 510, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored on a computer readable medium that, when executed by the one or more processors, manipulate the one or more processors to perform one or more aspects of the techniques described above. The software is stored or otherwise tangibly embodied on a computer readable storage medium accessible to the processing system, and can include the instructions and certain data utilized during the execution of the instructions to perform the corresponding aspects.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method, comprising:
during operation of a processor, flushing a cache in response to the processor entering a first low-power state;
setting a number of ways of a cache to a first size in response to the processor exiting a first low-power state; and
adjusting the number of ways of the cache from the first size to a second size by changing a number of ways of each set of the cache available to store data in response to identifying a first level of processing activity at the processor.

2. The method of claim 1, further comprising:
placing the processor in a second low-power state; and
setting the number of ways of the cache to the second size in response to the processor exiting the second low-power state.

3. The method of claim 2, wherein the second size is greater than the first size.

4. The method of claim 2, further comprising maintaining data at the cache in response to placing the processor in the second low-power state.

5. The method of claim 1, wherein adjusting the number of ways of the cache further comprises:
adjusting the number of ways of the cache from the second size to a third size in response to a second level of processing activity at the processor.

6. The method of claim 5, wherein the second size is greater than the first size and the third size is smaller than the second size.

7. The method of claim 5, wherein the second size is smaller than the first size and the third size is greater than the first size.

8. The method of claim 1, wherein adjusting the number of ways of the cache comprises adjusting the number of ways of the cache in response to a context switch at the processor indicating a processor core of the processor has switched from executing a first thread to executing a second thread.

9. The method of claim 1, wherein the cache is shared between a first processor core and a second processor core of the processor.

10. A method, comprising:
setting a size of a set-associative cache of a processor to a first number of ways in response to the processor exiting a first low-power state; and
setting the size of the cache to a second number of ways in response to the processor exiting a second low-power state.

11. The method of claim 10, further comprising:
flushing data from the cache in response to the processor entering the first low-power state; and
maintaining data at the cache in response to the processor entering the second low-power state.

12. The method of claim 10, further comprising:
dynamically changing the size of the cache from the first number of ways to a third number of ways based on processing activity at the processor.

13. The method of claim 12, wherein the third number of ways is smaller than the second number of ways.

14. The method of claim 12, further comprising changing the size of the cache from the third number of ways to the second number of ways based on processing activity at the processor.

15. A processor, comprising:
a processor core;
a cache; and
a cache controller to:
set a size of a set-associative cache of a processor to a first number of ways in response to the processor exiting a first low-power state; and
set the size of the cache to a second number of ways in response to the processor exiting a second low-power state.

16. The processor of claim 15, wherein the cache controller is to:
flush data from the cache in response to the processor entering the first low-power state; and
maintain data at the cache in response to the processor entering the second low-power state.

17. The processor of claim 15, wherein the cache controller is to:
dynamically change the size of the cache from the first number of ways to a third number of ways based on processing activity at the processor core.

18. The processor of claim 17, wherein the second number of ways is larger than the third number of ways.

19. The processor of claim 17, wherein the cache controller is to:
adjust the size of the cache from the third number of ways to the second number of ways in response based on processing activity at the processor core.

20. The processor of claim 15, wherein the second number of ways is a maximum size of the cache.
